(19) United States
(12) Patent Application Publication
(10) Pub. No.: US 2007/0093238 A1
(43) Pub. Date: Apr. 26, 2007

(54) System for video conference, proxy server and method thereof

(75) Inventor: Ching-Yu Lin, Hsinchu (TW)

Correspondence Address: REED SMITH LLP, Suite 1400, 3110 Fairview Park Drive, Falls Church, VA, 22042, US

(73) Assignee: BenQ Corporation

(21) Appl. No.: 11/544,711

(22) Filed: Oct. 10, 2006

(30) Foreign Application Priority Data
Oct. 12, 2005 (TW) 094135494

(51) Int. Cl. H04M 3/42

(52) U.S. Cl. 455/416

(57) ABSTRACT

A system for video conference, proxy and method thereof are provided. The system includes a first mobile device with video service, configured to capture a first image; a second mobile device with video service, connected to the first mobile device by using a first network protocol; a first computer with video service, configured to capture a second image; a second computer with video service, configured to capture a third image and connected to the first computer by using a second network protocol; and a proxy server connected to the first and the second computers by using the second network protocol and connected to the second mobile device by using a third network protocol. The proxy server can combine the second image and the third image into a fourth image and transmit the fourth image to the first mobile device via the second mobile device.

### FIELD OF INVENTION

The present invention generally relates to a system, a proxy server and a method for providing a video conference, and more particularly, to a system, a proxy server and a method for providing a video conference in a heterogeneous environment.

### BACKGROUND OF THE INVENTION

Although 3G cellular network provides the service of video conference, the service is mainly for one-to-one video conference, and as for most of other networks and mobiles, the multi-party video conference is still unavailable. In addition, 3G mobile device is not popular yet and its active range is limited. The cost will be expensive by using multiple 3G mobile devices to set up a multi-party video conference. Therefore, it is inconvenient to set up a multi-party video conference via the cellular network. In view of the need of video conference is increasing, many researches and developments on this issue are ongoing. For example, US patent publication number 2003/0147381 discloses a method for multiple mode voice and data communications using bridged TDM and packet buses.

The coverage of the present wireless local area network (WLAN) is quite wide and the notebooks/handsets with WLAN access capability are getting more and more popular. Therefore, the video communication based on IP network has been widely developed and adopted, with several standards generated for the frame protocol of the IP Telephony. And, the H.323 standard holds the dominate position for video communication in the IP Telephony market. The H.323 standard is consisted of several related standard protocols, including H.225 call signaling, H.245 control signaling, and real-time transport protocol (RTP), etc. The H.323 standard specifies how real time services may be implemented over IP networks.

Accordingly, it is advantageous to have a system and a method to combine the video telephones of Internet and the cellular network for setting up a multi-party video conference more easily and economically.

### SUMMARY OF THE INVENTION

In view of the above described problems existing in the art, one aspect of the present invention is to provide a system for a video conference and a method for setting up the video conference in a heterogeneous environment, wherein the devices in different protocol networks are connected to a proxy server.

According to another aspect of the present invention, the video telephone information in the Internet are combined with the video telephone information in the wireless cellular network to enable a video conference over a heterogeneous environment.

According to further another aspect of the present invention, a system for video conference is provided, including a first mobile device, a second mobile device, a first computer, a second computer, and a proxy server. The first mobile device communicates with the second mobile device by a first network protocol, the first computer communicates with the second computer by a second network protocol, and the proxy server connects to the first and the second computers by the second network protocol and connects to the second mobile device by a third network protocol. The first mobile device is configured to capture a first image, the first computer is configured to capture a second image, and the second computer is configured to capture a third image, wherein the second and the third image are combined into a forth image by the proxy server. The forth image is transmitted to the first mobile device via the second mobile device, and the first image is received by the second mobile device and transmitted to the first computer and the second computer by the second network protocol.

According to yet another aspect of the present invention, a proxy server for setting up a video conference is provided, including a buffer device, a encode/decode device, and an audio mixer.

According to still another aspect of the present invention, a method for setting up a video conference is provided, including the following steps: capturing a first image by a first mobile device; a second mobile device communicating with the first mobile device by a first network protocol; capturing a second image by a first computer; capturing a third image by a second computer; the first computer communicating with the second computer by a second network protocol; a proxy server connecting to the first and the second computers by the second network protocol and connecting to the second mobile device by a third network protocol; the proxy server combining the second image and the third image into a fourth image and transmitting the fourth image to the first mobile device; and the proxy server receiving the first image via the second mobile device and transmitting the first image to the first computer and the second computer.

According to a further aspect of the present invention, a proxy server for setting up connections between multiple heterogeneous networks is provided, including a first access device configured to connect to a mobile device in the first network, and a second access device configured to connect to a computer in the second network. The proxy server connects to a third network via the second mobile device and the computer in the second network connects to a third network via the proxy server.

### BRIEF DESCRIPTION OF THE PICTURES

The foregoing aspects and many of the attendant advantages of this invention will become more readily appreciated as the same becomes better understood by reference to the following detailed description, when taken in conjunction with the accompanying pictures, wherein:

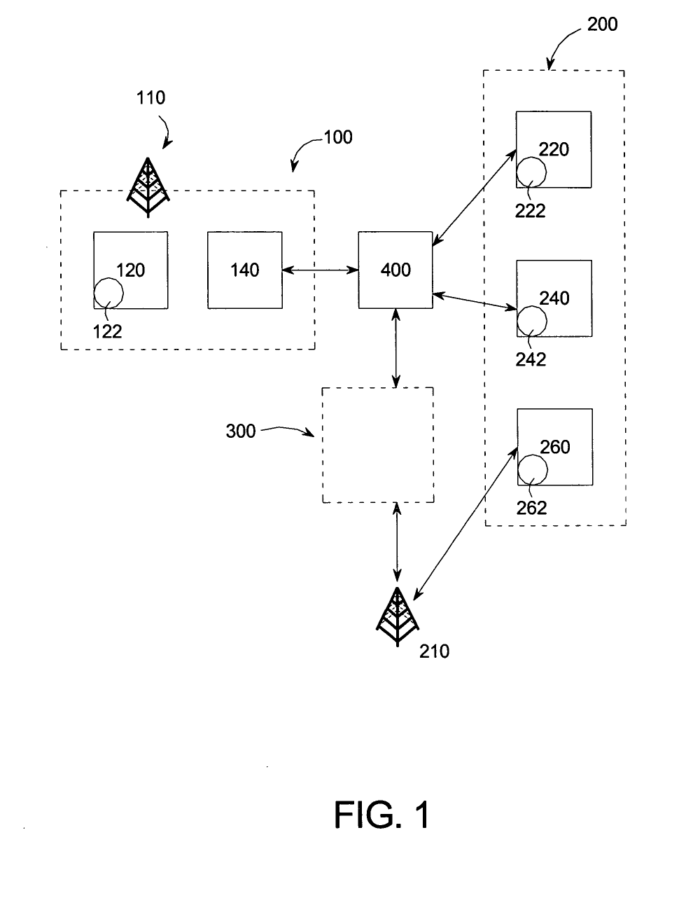

FIG. 1 illustrates a system for setting a video conference over a heterogeneous environment in accordance with the present invention;

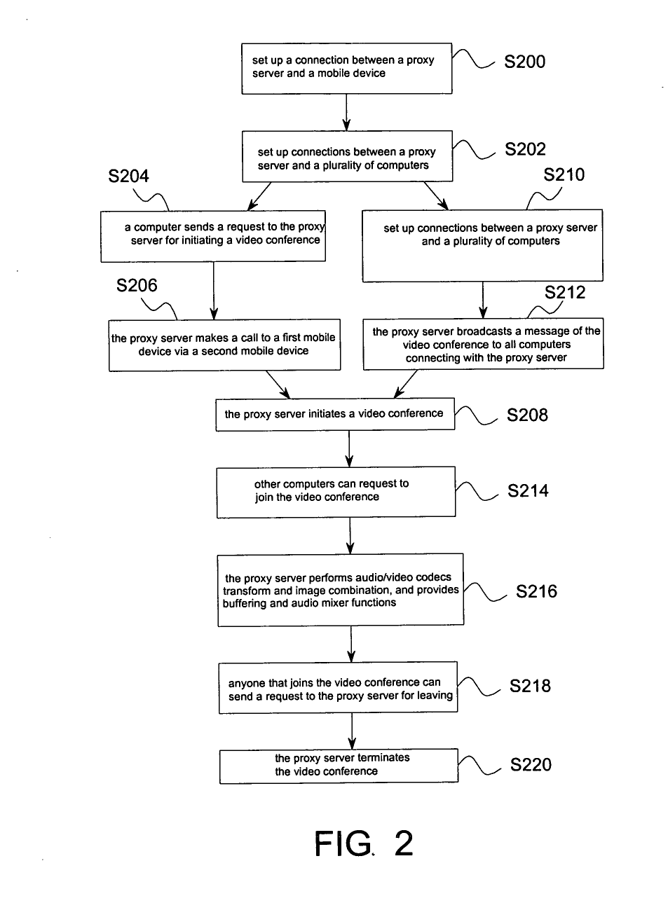

FIG. 2 is a flowchart showing the procedure of setting up a video conference in accordance with the present invention; and

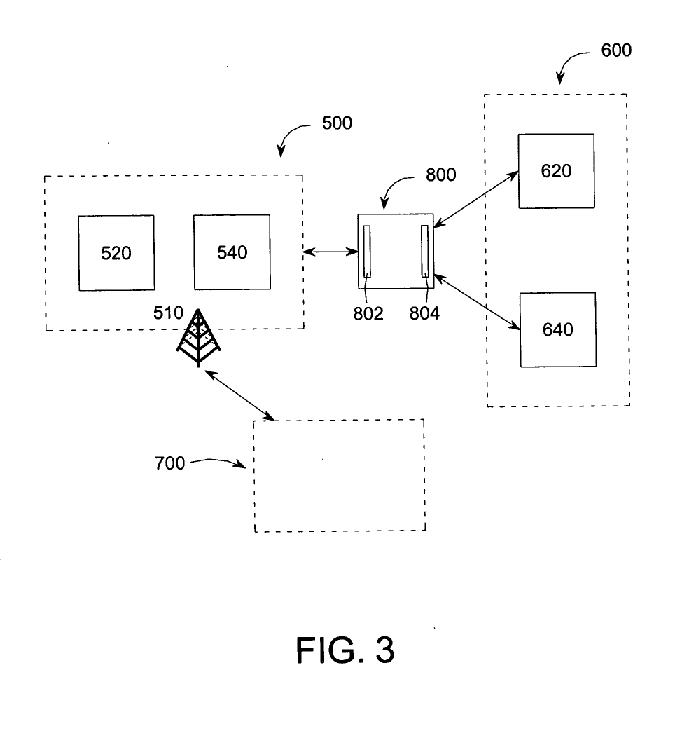

FIG. 3 illustrates a proxy server for providing a connection between multiple heterogeneous networks in accordance with the present invention.

### DETAILED DESCRIPTION OF THE INVENTION

In order to accomplish the foregoing features and functions, the present invention discloses a system, a proxy server, and a method for providing a video conference. The present invention will be described more fully hereinafter with reference to the FIGS. 1-3. However, the devices, elements, and methods in the following description are configured to illustrate the present invention, and should not be construed in a limiting sense.

FIG. 1 illustrates a system for video conference in a heterogeneous environment according to an embodiment of the present invention. A first network system 100 includes a first mobile device 120 capable of capturing a first image 122 and a second mobile device 140. Both the first and second devices 120 and 140 can setup a video exchange function and communicate with each other by a first network protocol via a base station 110. An image capture device (not shown), such as a camera or a video camera, may be placed within the first mobile device 120 for capturing the images. For example, the first mobile device 120 and the second mobile device 140 can be 3G mobile phones with video telephony 3G-324M capability. The second network system 200 includes a first computer 220 for capturing a second image 222, a second computer 240 for capturing a third image 242, and a third computer 260 for capturing an fourth image 262. The first, second, and third computers 220, 240, 260 have the function of video exchange and communicate with one another by a second protocol. For example, the first computer 220, the second computer 240, and the third computer 260 can be a typical laptop or notebook with WLAN access capabilities. The proxy server 400 can communicate with the first computer 220 and the second computer 240 by the second network protocol. The proxy server 400 can also communicate with the third computer 260 by a WLAN AP 210 through Internet 300. In addition, the proxy server 400 can also connect to the second device 140 in the first network system 100 by the third network protocol. For example, the third network protocol may be V.80 protocol (V.80 is streaming protocol between a modem and a computer). For example, a video camera may be placed within each of the first mobile device 120, the first computer 220, the second computer 240 and the third computer device 260 to implementing the function of image capture.

In one embodiment of the present invention, when the first computer 220 intends to initiate a video conference, it will make a video call to the proxy server 400 for requesting to set up a video conference. Because the video codecs defined by the first protocol are different from the video codecs defined by the second protocol, such as the differences in the resolution of the image format or the audio format, the proxy server 400 will perform the audio/video codec transformation between the first and the second protocols after receiving the video call. The proxy server 400 can make a video telephony from the second mobile device 140 to the first mobile device 120 by using AT command during the video codec transformation. When the first mobile device 120 makes an active response, the connection between the first mobile device 120 and the proxy server 400 is set up by connecting the first mobile device 120 with the second mobile device 140 via the first network protocol and connecting the second mobile device 140 with the proxy server 400 via the third network protocol, and then the proxy server 400 will notice the first computer 220 such that the video conference between the first computer 220 and the first mobile device 120 is initiated. When the video conference is created, anyone that connects to the proxy server 400, such as the second and third computers 240 and 260 can request to join the video conference. The proxy server 400 can permit or deny the requests from these computers by using known authentication mechanism. For example, the second computer 240 and the third computer 260 can send messages to the proxy server 400 respectively for requesting to join the video conference, and the proxy server 400 will invite the second computer 240 and the third computer 260 to join the video conference if it accepts these requests and completes the codecs transformation such that the video conference now is among the first computer 220, the second computer 240, the third computer 260 and the first mobile device 120.

In another embodiment of the present invention, when the first mobile device 120 intends to initiate a video conference, it makes a video telephony call to the second device 140 via the first network system 100 to instruct the proxy server 400 to initiate a video conference. After receiving the instruction, the proxy server 400 broadcasts a message of “video conference call” to all the computers connected to it. If the first computer 220 makes an active response to this message, the video conference call will be accepted and go into active state such that the video conference between the first computer 220 and the first mobile device 120 will be created. As described above, the proxy server 400 will also perform the audio/video codec transformation between the first and the second network protocols, and other computers can ask for joining the video conference.

During the video conference, a first image/video 122, a second image/video 222, a third image/video 242, and a forth image/video 260 captured by the first mobile device 120, the first computer 220, the second computer 240, and the third computer 260, respectively, will be transmitted to the proxy server 400. Therefore, the proxy server 400 needs to combine images/videos and voices for synchronizing the images//videos and voices of all members joining the video conference. The proxy server 400 can transmit the first image/video 122 to the first, second and third computer 220, 240, 260, respectively, via the second network protocol. In other words, the proxy server 400 acts as an agent of the first mobile device 120 to participate in the video conference with the first, second and third computer 220, 240, 260 based on the second network protocol. Besides, the proxy server 400 combines the second, third and fourth images/videos 222, 242, 262 into a fifth image/videos (not shown) and transmits the fifth image/video to the first mobile device 120, i.e. the proxy server 400 has an one-to-one video conference with the first mobile device 120 based on the first network protocol. According to another embodiment of the present invention, the proxy server 400 may combine the first image/video 122, the second image/video 222, the third image/video 242 and the fourth image/video 262 into one video frame, then transmit the video frame to the first mobile device 120, the first computer 220, the second computer 240, and the third computer 260, respectively, i.e. every communication unit has an one-to-one video conference with the proxy server 400 based on the first and the second network protocols.

In addition, in order to solve the problem of delay associated with the members joining the video conference communicating with each other, the proxy server 400 may need to do buffering to guarantee video quality and performance. Besides, since the proxy server 400 receives the audio sources from all members in the video conference during the video conference, the proxy server 400 may need to provide audio mixer function and guarantee the audio streaming quality.

During the video conference among the first computer 220, the second computer 240, the third computer 260, and the first mobile device l20, if the first computer 220 wants to leave the video conference, it can send a request to the proxy server 400 for leaving, and then leave the video conference after the proxy server 400 grants the request. When the last one which connects to the video proxy server leaves the video conference, the proxy server 400 will terminate the video conference. At this point, the connection between the first mobile device 120 and the second mobile device 140 via the first network protocol is broken, and the first mobile device 120 and the second mobile device 140 are back to the idle state.

In the above-mentioned embodiments, the present invention requires only one time expense on a video telephony call and makes multi-party video conference, without time or location restriction.

To sum up, FIG. 2 illustrates a flow chart showing the procedure of a video conference according to an embodiment of the present invention. In step S200, a proxy server connects to a second mobile device by, for example, V.80 protocol, and the second mobile device communicates with a first mobile device by a first network protocol (such as 3G-324M protocol). In step 202, the proxy server connects to a plurality of computers by using wireless local network protocol or by using Internet protocol and a wireless local network bridge. If a first computer wants to initiate a video conference, the procedure proceeds to step S204, and the first computer sends a request to the proxy server for setting up a video conference. In step S206, the proxy server makes a video telephony call to the first mobile device via the second mobile device after receiving the request. When the first mobile device makes an active response to this call, the proxy server will initiate a video conference between the first computer and the first mobile device, as shown in step S208. In step S202, if the first mobile device wants to initiate a video conference, the procedure will proceed to step S210, and the first mobile device sends a request to the proxy server via the second mobile device for setting up a video conference. In step S212, after the proxy server receives the request, it broadcasts a message of the video conference to all computers connecting to the proxy server. If one computer makes an active response to this message, the proxy server will initiate a video conference between the first mobile device and the computer making the response, as shown in step S208. In step S214, when the video conference is created, any computer that connects to the video proxy server can request to join the video conference, and the proxy server can grant or deny the requests from these computers by using known authentication mechanism. In step S216, during the video conference, the proxy server will do audio/video codecs transformation and image combination among different networks, and provide buffering function and audio mixer function. In step S218, anyone that joins this video conference may send a request to the proxy server for leaving, and leaves the video conference after the request is granted by the proxy server. In the step S220, the proxy server will terminate the video conference when the last one which connects the video proxy server leaves the video conference.

FIG. 3 illustrates a proxy server 800 configured to provide a connection between multiple heterogeneous networks according to an embodiment of the present invention. A first network system 500 includes a first mobile device 520, a second mobile device 540 and a base station 510. A second network system 600 includes a first computer 620 and a second computer 640. The proxy server 800 has a first access device 802 configured to connect to the first network system 500 and a second access device 804 configured to connect to the first and the second computers 620 and 640. The proxy server 800 can connect to the first mobile device 520 through the second mobile device 540 and the base station 510. In one embodiment, the first network system 500 is a cellular network, the second network 600 is a WLAN. The proxy server 800 can act as a data transfer proxy server between the cellular network 500 and the wireless local network 600 by Internet protocol. In addition, the proxy server 800 in FIG. 3 can also be configured to set up a video conference between the cellular network 500 and the wireless local network 600, or between the first mobile device 520 and the first and the first computer 620 and the second computer 640. The proxy server 800 also has a buffer device, an encode/decode device and an audio mixer (not shown in FIG. 3); the buffer device configured to provide a buffer for a delay associated with the first and the second mobile devices communicating with the first and the second computers; the encode/decode device configured to provide a function of codex transformation of audio/video signals; and the audio mixer configured to provide a function of mixing audio signals. The encode/decode device mixes videos from the first computer and the second computer then transmitting to the first mobile device when a video conference setup between the first mobile device 520 and the first and the first computer 620 and the second computer 640.

During the video conference, the proxy server 800 can perform the following functions: the video frame transformation between the mobile devices and computers, the combination of images/videos, buffering, audio/video codec transform, and audio mixer, etc.

Although the specific embodiments of the present invention have been illustrated and described, it is to be understood that the invention is not limited to those embodiments. One skilled in the art may make various modifications without departing from the scope or spirit of the invention.

1. A system for video conference, comprising:
a first mobile device configured to capture a first image;
a second mobile device communicating with the first mobile device by a first network protocol;
a first computer configured to capture a second image;
a second computer configured to capture a third image, the second computer communicating with the first computer by a second network protocol; and
a proxy server connected to the first and the second computers by the second network protocol and connected to the second mobile device by a third network protocol, wherein the proxy server combines the second image and the third image into a fourth image and transmits the fourth image to the first mobile device by the second mobile device.

2. The system of claim 1, wherein the proxy server receives the first image from the first mobile device via the second mobile device, and transmits the first image to the first computer and the second computer by the second network protocol.

3. The system of claim 2, wherein the proxy server sets up a video conference by transmitting the first image and the forth image, the proxy server further comprising:
a buffer device configured to provide a buffer for a delay associated with the first and the second mobile devices communicating with the first and the second computers;
a encode/decode device configured to provide a function of codex transformation of audio/video signals; and
an audio mixer configured to provide a function of mixing audio signals.

4. The system of claim 1, wherein the first network protocol is a 3G-324M protocol.

5. The system of claim 1, wherein the second network protocol is an Internet protocol and/or a WLAN (wireless local area network) protocol.

6. The system of claim 1, wherein the third network protocol is a V8.0 protocol.

7. A method for providing a video conference, comprising the following steps:
capturing a first image by a first mobile device;
a second mobile device communicating with the first mobile device by a first network protocol, the first and the second mobile devices connecting for video exchanging;
capturing a second image by a first computer;
capturing a third image by a second computer;
the first computer communicating with the second computer by a second network protocol, the first and the second computers connecting for video exchanging;
a proxy server connecting to the first and the second computers by the second network protocol;
the proxy server connecting to the second mobile device by a third network protocol; and
combining the second image and the third image into a fourth image by the proxy server, and transmitting the fourth image to the first mobile device by the second mobile device.

8. The method of claim 7, further comprising the following steps:
the proxy server receiving the first image from the first mobile device by the second mobile device; and
the proxy server transmitting the first image to the first computer and the second computer by the second network protocol

9. The method of claim 8, wherein the proxy server sets up a video conference by transmitting the first image and the forth image, the proxy server further comprising:
a buffer device configured to provide a buffer for a delay associated with the first and the second mobile devices communicating with the first and the second computers;
a code/decode device configured to provide a function of codex transformation of audio/video signals; and
an audio mixer configured to provide a function of mixing audio signals.

10. The method of claim 7, wherein the first network protocol is a 3G-324M protocol.

11. The method of claim 7, wherein the second network protocol is an Internet protocol and/or a WLAN (wireless local area network) protocol.

12. The method of claim 7, wherein the third network protocol is a V8.0 protocol.

13. A proxy server for providing connections between multiple heterogeneous networks, comprising:
a first access device configured to connect to a second mobile device by a first network protocol; and
a second access device configured to connect to a first and a second computer by a second network protocol, wherein the first computer communicating with the second computer by the second network protocol;
wherein the proxy server connects to a first mobile device by the second mobile device by the first network protocol, and the first and the second computers connect to the first mobile device through the proxy server.

14. The proxy server of claim 13, wherein the proxy server sets up a video conference when receiving a request from one of the first mobile device, the first computer and the second computer for enabling the video conference.

15. The proxy server of claim 13, further comprising:
a buffer device configured to provide a buffer for a delay associated with the first and the second mobile devices communicating with the first and the second computers;
a encode/decode device configured to provide a function of codex transformation of audio/video signals; and
an audio mixer configured to provide a function of mixing audio signals.

16. The proxy server of claim 13, wherein the first network protocol is a 3G-324M protocol.

17. The proxy server of claim 13, wherein the second network protocol is a WLAN (wireless local area network) protocol.

18. The proxy server of claim 13, wherein the first access device is a V8.0 interface.

19. The proxy server of claim 13, wherein the encode/decode device mixed videos from the first computer and the second computer then transmitting to the first mobile device.
